(19) United States
(12) Patent Application Publication
(10) Pub. No.: US 2015/0293034 A1
(43) Pub. Date: Oct. 15, 2015

(54) INSPECTION DEVICE AND INSPECTION METHOD

(71) Applicant: HITACHI HIGH-TECHNOLOGIES CORPORATION, Minato-ku, Tokyo (JP)

(72) Inventors: Masami Makuuchi, Tokyo (JP); Takahiro Jingu, Tokyo (JP)

(21) Appl. No.: 14/440,029

(22) PCT Filed: Oct. 23, 2013
(86) PCT No.: PCT/JP2013/078659

§ 371 Date: Apr. 30, 2015

(30) Foreign Application Priority Data
Oct. 31, 2012 (JP) 2012-240522

(51) Int. Cl. G01N 21/95; G01J 1/44

(52) U.S. Cl. CPC G01N 21/9501; G01J 1/44; G01J 2001/4238

(57) ABSTRACT

To provide a technique for improving a detection precision of the inspection device. The inspection device 100 includes an irradiation unit 101 that irradiates a beam by pulse oscillation onto a surface of the sample from a laser light source, a detection unit 102 on which light from the surface of the sample by the irradiation is made incident to generate and output a detection signal, and a detection control unit 104 that generates a gate signal (G) for controlling an input/output of the detection unit 102 in synchronization with a timing of the pulse oscillation of the irradiation unit 101, and applies the gate signal (G) to the detection unit 102. The detection unit 102 allows the light to be made incident thereon at a timing in accordance with the gate signal (G), and generates and outputs a detection signal.

### TECHNICAL FIELD

The present invention relates to measurement and inspection techniques for a sample.

### BACKGROUND ART

As measurement and inspection techniques for a sample, an inspection device and an inspection method are proposed in which a beam is applied from a laser light source onto a surface of a sample such as a semiconductor wafer or the like, and by detecting its scattered light or the like by light detection means, a state including a fine foreign matter, a defect or the like onto the surface of the sample is measured and inspected.

As a related-art example relating to the above-mentioned inspection device, it is proposed in Japanese Unexamined Patent Application Publication (Translation of PCT Application) No. 2005-526239 (Patent Document 1) or the like.

The Patent Document 1 describes, for example, that “a mechanism for detecting an intensity value having a comparatively large dynamic range from a beam (for example, scattered light, reflected light or secondary electrons) emitted by a sample such as a semiconductor wafer has been provided” (see Abstract).

As a light detection element for use as light detection means in the above-mentioned inspection device, for example, semiconductor light detection elements, such as a PMT (Photo Multiplier Tube), an APD (Avalanche Photo Diode) or the like, and a MPPC (Multi-Pixel Photon Counter; registered trademark of Hamamatsu Photonics K.K.) or the like are proposed. The PMT is a detector in which an incident light is converted to an electron inside a vacuum tube and the electron is multiplied for the detection, and this one has been conventionally used in many cases. The APD is a solid-type light detection element in which by applying a voltage (reverse bias voltage) exceeding a predetermined level to a photodiode, amplification is caused by an avalanche effect. The technique for photon-counting operation (counting photons) by utilizing the APD includes a Geiger mode.

The behavior of the APD is, for example, described in the following manner. In the case when a voltage (reverse bias voltage) exceeding a breakdown voltage is applied to the APD and when a photon is made incident thereon in this state (referred to as a Geiger mode), a breakdown occurs stochastically, so that a large electric current flows. Moreover, by the voltage drop by a series resistance of the APD, the voltage of the APD is lowered below the breakdown voltage, so that the large electric current is stopped. During the above-mentioned mode (Geiger mode), even when photons are continuously made incident, a constant voltage is kept. Pulses at this time are counted (counted as one signal). Thereafter, the voltage of the APD rises again. During the times of the above-mentioned breakdown and the voltage rise, the pulses of the photon detection are not outputted, and a certain period of time is required for recovery so as to enable the next pulse to be outputted.

An MPPC is one kind of a new type optical sensor that is generally referred to as PPD (Pixelated Photon Detector), and is also referred to as SiPM (Silicon Photo Multiplier) or the like, and this has been progressively developed and utilized in recent years. The MPPC is a semiconductor light receiving element composed of a plurality of APD pixels (or an array thereof), and a photon detector/measuring device. By operating each of the APD pixels of the MPPC with the above-mentioned Geiger mode (operated at a voltage that saturates the output of the pixel), photons to be made incident thereon can be sensed. In the MPPC, a signal corresponding to the total number of pixels (pulses thereof) on which photons (single photon) are made incident is outputted. The MPPC is provided with good characteristics such as a high photon detecting efficiency because of a high multiplication factor.

With respect to the above-mentioned MPPC, for example, it is described in Japanese Patent Application Publication No. 2012-135096 (Patent Document 2).

The Patent Document 2 describes “To provide a device for finely adjusting an applied voltage to the element”, or the like (see Abstract).

In particular, in the case when the MPPC is used as light detection means, as described in Patent Document 2, in order to allow a semiconductor light detection element to output a predetermined voltage in response to an optical input with a predetermined light quantity, means for adjusting the applied voltage to the semiconductor light detection element needs to be provided in the light detection means (MPPC).

### RELATED ART DOCUMENTS

### Patent Documents

Patent Document 1: Japanese Unexamined Patent Application Publication (Translation of PCT Application) No. 2005-526239

Patent Document 2: Japanese Patent Application Publication No. 2012-135096

### SUMMARY OF THE INVENTION

### Problems to be Solved by the Invention

By using an element such as APD-MPPC or the like, as the light detection means in an inspection device by a laser system with a wafer surface or the like serving as a target (sample), feeble light from the sample can be measured, so that even a fine defect can be detected.

Dark noise is present in the MPPC element (APD pixel) as its characteristic. The dark noise is considered to be generated mainly by the fact that electrons mainly caused by thermal excitation are avalanche-amplified to form a signal. At the time of a Geiger mode operation of the APD, the noise component is also multiplied. As the number of APD pixels increases, the dark noise also increases. As an incentive of the dark noise, an intermediate level caused by an impurity or the like has been considered. In the case of application to an inspection device, it is demanded that the level of dark noise should be suppressed.

The above-mentioned Patent Document 1 describes a technique in which upon irradiation onto the surface of a wafer with a beam, the intensity of scattered light from a foreign matter onto the surface of the wafer is detected with a comparatively great dynamic range. However, for example, in the case when the intensity of scattered light from the foreign matter on the wafer becomes minute in accordance with the diameter of the foreign matter, the ratio of the sensor element itself occupied by the dark noise becomes greater in the detection signal outputted from the sensor, thereby making it difficult for the device of Patent Document 1 to detect a minute foreign matter. Moreover, the laser light source is produced by pulse oscillation, so that a pulse component of the laser light source is also superimposed on a detection signal to be outputted from the sensor, thereby making it difficult to detect the foreign matter with high precision.

In addition to the above problem, in particular, when an MPPC is used as light detection means of the inspection device, the following problems are raised. The beam of the laser light by the pulse oscillation from the laser light source is applied onto the surface of a wafer serving as a sample, and light emission of scattered light from a foreign matter or the like serving as a detection target is made incident on the MPPC (APD pixel) to be measured. At this time, a state stochastically occurs in which, due to influences of reflected light from the surface of a wafer and stray light located inside the device, when light is made incident on the MPPC (APD pixel) except for the light emission of the above-mentioned scattered light, the charge accumulated in the MPPC (APD pixel) is multiplied and outputted as an undesired signal. That is, due to the above-mentioned behavior of the APD and the influences of dark noise, the precision of the detection signal tends to deteriorate. In the case of the means of the above-mentioned Patent Document 2, when laser light by pulse oscillation is made incident, if the charge accumulation to the MPPC (APD pixel) has not been completed before that, due to the influences of the reflected light and stray light, the precision of the detection signal deteriorates.

As described above, with respect to the light detection means (light detection element) of the inspection device, the conventional techniques cause the following problems: (1) deterioration of detection precision due to the influences of dark noise of the inspection device and the light detection element; (2) deterioration of detection precision due to influences of the pulse oscillation of the laser light source; and (3) deterioration of detection precision due to influences of reflected light and stray light in the light detection elements, such as the MPPC or the like using charge accumulation.

In view of the above-mentioned problems, the present invention provides a technique that can improve the detection precision of the inspection device.

### Means for Solving the Problems

To solve the above problem, for example, the structures described in claims are adopted.

The present application includes a plurality of means for solving the above problem. One of the examples of such means is as below. The present invention is characterized in that “an inspection device that measures and inspects a state of a sample includes: an irradiation unit that irradiates a beam by pulse oscillation onto a surface of the sample from a laser light source; a detection unit on which light from the surface of the sample by the irradiation is made incident to generate and output a detection signal; and a detection control unit that generates a first signal for controlling an input/output of the detection unit in synchronization with a timing of the pulse oscillation of the irradiation unit, and applies the first signal to the detection unit. The detection unit allows the light to be made incident thereon at a timing in accordance with the first signal, and generates and outputs the detection signal.”

### Effects the Invention

According to the typical aspect of the present invention, a detection precision of the inspection device can be improved.

### BRIEF DESCRIPTIONS OF THE DRAWINGS

FIG. 1 shows configurations of an inspection device and an inspection method in accordance with a basic embodiment of the present invention.

FIG. 2 shows a configuration of an inspection device in accordance with a first embodiment of the present invention.

FIGS. 3(A) and 3(B) show a circuit configuration and an operation example of a sensor of the inspection device in accordance with the first embodiment.

FIG. 4 shows a configuration of an equivalent circuit of an MPPC serving as the sensor of the first embodiment.

FIG. 5 shows a circuit configuration of a sensor of an inspection device in accordance with a second embodiment of the present invention.

FIG. 6 shows a configuration of an inspection device in accordance with a third embodiment of the present invention.

FIGS. 7(A) and 7(B) show a circuit configuration and an operation example of a sensor of the inspection device in accordance with the third embodiment.

FIG. 8 shows pulse signals as a supplement to the embodiments.

### DETAILED DESCRIPTION

Hereinafter, embodiments of the present invention will be described in detail with reference to the accompanying drawings. Note that members having the same function are denoted by the same reference symbols throughout all drawings for describing the embodiments, and the repetitive description thereof will be omitted. In addition, the control line, etc. in the drawings show necessary portions for explanation.

<Outline, etc.>

In the following description, explanation will be given by exemplifying the application of the present invention to an inspection device of a dark visual field optical system (in which a beam from a laser light source is irradiated onto a sample in a dark visual field and the resulting scattered light is detected by a sensor). The inspection device and inspection method in the following description will describe, for example, a configuration for inspecting a foreign matter, a defect or the like onto the surface of a sample, such as a semiconductor wafer or the like, which can reduce influences of dark noise of a light detection element (hereinafter, also referred to as a sensor), influences caused by pulse oscillation of a laser light source, and influences caused by reflected light and stray light.

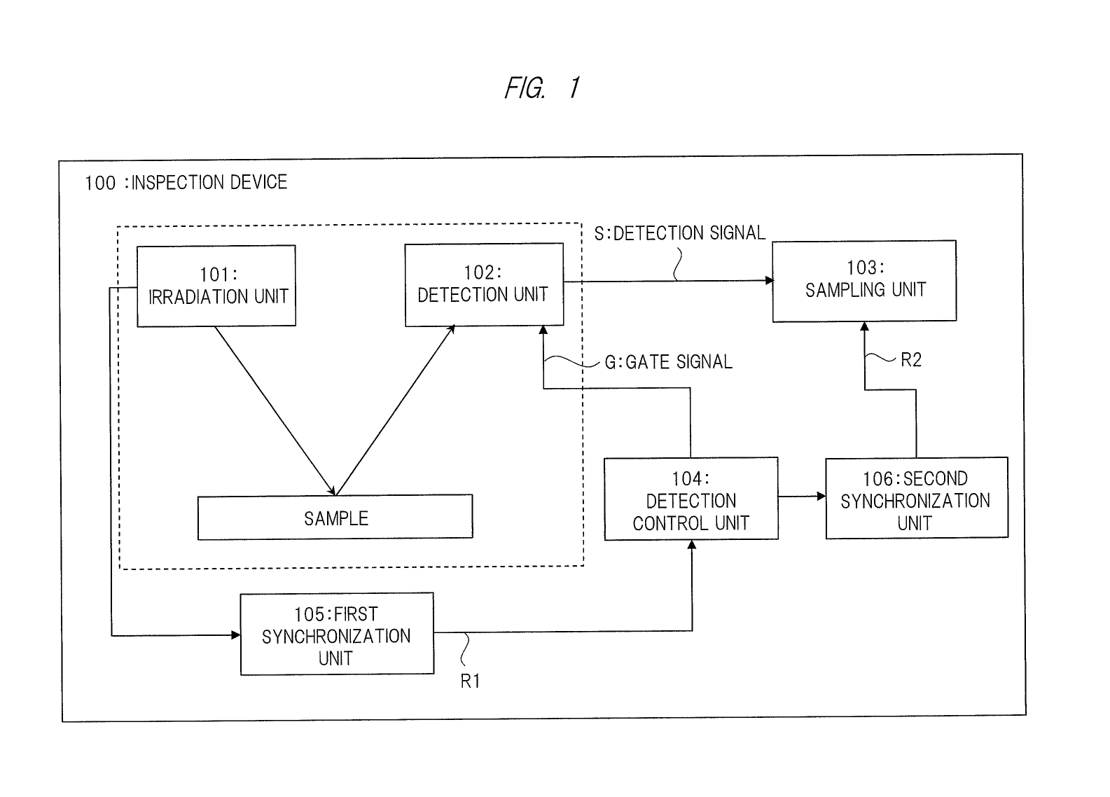

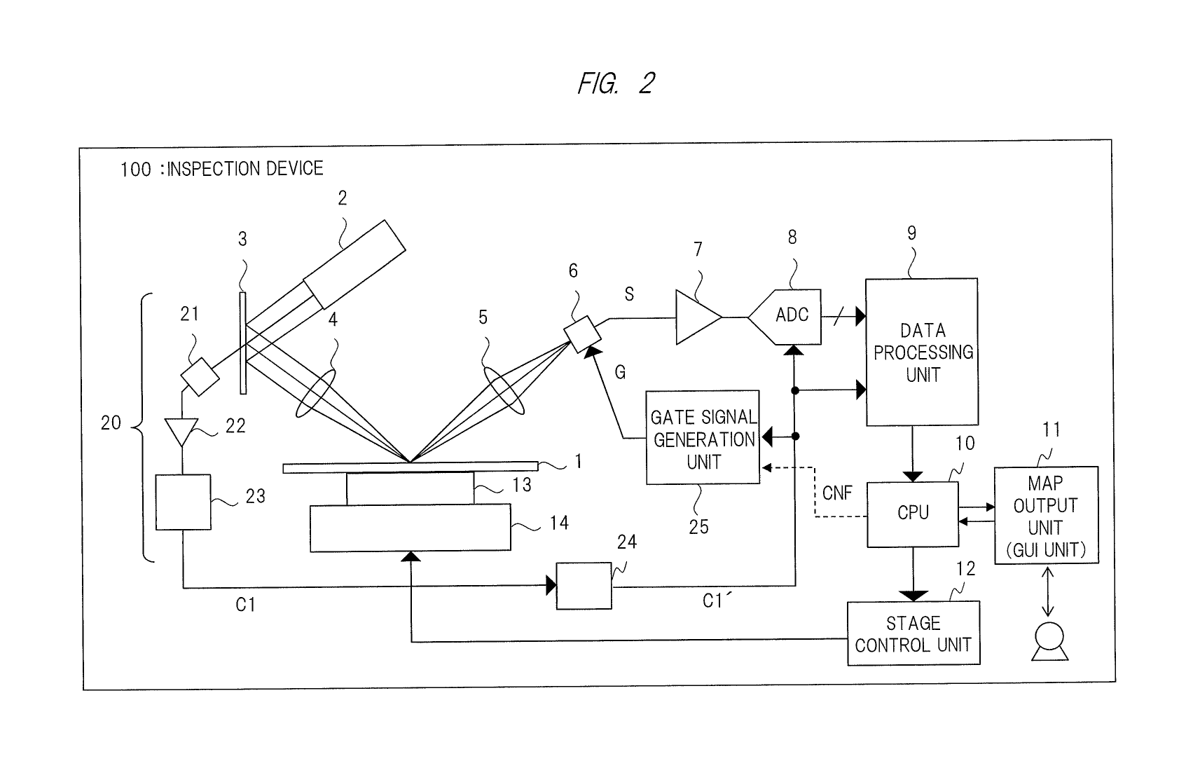

In the inspection device and the inspection method of the present embodiment, as means for controlling charge accumulation onto a light detection element, such as an APD, MPPC (PPD) or the like, the following means is provided. That is, the means (that is, a detection control unit 104 of FIG. 1, a gate signal generation unit 25 of FIG. 2, or the like) for generating and controlling a signal (hereinafter, referred to as “gate signal”), which performs dynamically ON/OFF control of operations and input/output processes of a light detection element (detection unit) in synchronization with a beam by pulse oscillation from a laser light source (irradiation unit), in other words, a signal that switches and controls a gain and a multiplication rate of the light detection element by using at least 2 values having a large one and small one, is provided.

<Basic Configuration>

FIG. 1 shows configurations of an inspection device 100 and an inspection method in accordance with a basic embodiment of the present invention. As shown in FIG. 1, the present inspection device 100 includes an irradiation unit 101, a detection unit 102, a sampling unit 103, a detection control unit 104, a first synchronization unit 105 and a second synchronization unit 106. The irradiation unit 101 is a configuration including a laser light source, and irradiates a wafer serving as a sample with a beam by pulse oscillation. The detection unit 102 allows light including scattered light from the wafer 1 serving as the sample caused by the beam of the irradiation unit 101 to be made incident thereon, and detects and outputs the resulting signal as a detection signal S in accordance with the characteristics of the light detection element. The detection unit 102 is configured to include, for example, light detection elements, such as APD, MPPC or the like. The sampling unit 103 has the detection signal S from the detection unit 102 inputted therein, and carries out a sampling process (quantization) thereon by analog/digital conversion to store or output the resulting sampling information as information for use in measurement/inspection.

The first synchronization unit 105 generates a reproduction signal R1 that is synchronized with the beam of pulse oscillation of the irradiation unit 101 as a first synchronous signal. The detection control unit 104 performs ON/OFF control of operations of the input/output of the scattered light of the detection unit 102 so as to be synchronized with the timing of the pulse of the beam irradiation of the irradiation unit 101. For this reason, the detection control unit 104 generates a gate signal G for the ON/OFF control in accordance with the reproduction signal R1 from the first synchronization unit 105, and applies this signal to the detection unit 102. The gate signal G is a signal including a pulse for the ON/OFF control. In accordance with the gate signal G, the detection unit 102 turns ON/OFF the incident light on the light detection element. In the ON state, the detection signal S is normally generated. In the OFF state, no light is made incident thereon (shut down), so that no detection signal S is generated.

Furthermore, the second synchronization unit 106 generates a second synchronous signal R2 that is synchronized with the reproduction signal R1 of the first synchronization unit 105 and the gate signal G of the detection control unit 104, and applies this signal to the sampling unit 103. By the second synchronous signal R2, the timing of the sampling of the detection signal S in the sampling unit 103 is synchronized with the timing of the detection in the detection unit 102.

By using the configuration in the above-mentioned inspection device 100 that includes the detection control unit 104 or the like for carrying out a control process to make the irradiation, detection and sampling synchronize with one another, with respect to the light detection element of the detection unit 102, it becomes possible to reduce influences of dark noise and influences of pulse oscillation of the laser light source in the irradiation unit 101, and to improve the detection precision of the light detection element by properly dealing with deterioration of the detection precision due to influences of reflected light and stray light.

In the inspection method to be carried out in the present inspection device 100, the method includes an irradiation step in which a pulse oscillation process is carried out to irradiate a laser beam onto the surface of a sample, a detection step in which the resulting scattered light from the surface of the sample is made incident and detected to generate and output a detection signal, a step of sampling the detection signal, a detection control step of generating a gate signal G in synchronization with the irradiation step and controlling the timing of the detection step, and a step of controlling the gate that is synchronized with the irradiation step and controlling a timing of sampling the detection signal of the detection step.

### First Embodiment

Referring to FIGS. 2 to 4, the first embodiment of the present invention will be described.

[Inspection Device]

FIG. 2 shows a configuration of an inspection device 100 in accordance with the first embodiment. The present inspection device 100 has the configuration including a laser light source 2, a reflection plate 3, lenses 4 and 5, a sensor (optical detection element) 6, an amplifier circuit 7, an ADC (analog/digital conversion circuit) 8, a data processing unit (data processing circuit) 9, a CPU 10, a map output unit (GUI unit) 11, a stage control unit 12, a rotation stage 13, a translation stage 14, a clock detection unit (in other words, synchronization unit) 20, a delay control unit 24, a gate signal generation unit 25, etc.

The present inspection device 100 is a device having a function that, with respect to a wafer 1 that is a sample serving as a target, carries out measurement and inspection on a state including a foreign matter, a defect or the like onto the surface of the wafer 1. The user (inspector) operates an input device that is built inside the present inspection device 100 or connected thereto, and carries out measurement and inspection operations, while referring to and operating the screen of the map output unit 11 serving as a GUI (graphical user interface) unit.

In the inspection device 100, the wafer 1 is installed onto the rotation stage 13, so that a laser light beam by pulse oscillation and outputted from the laser light source 2 is irradiated onto the wafer 1 through the reflection plate 3 and the lens 4. The focal points of the lenses 4 and 5 are set to the surface of the sample. At this time, in the inspection device 100, by the control of the CPU 10, the wafer 1 is rotated and operated on the rotation stage 13 through the stage control unit 12, and also linearly operated on the translation stage 14. Thus, the laser light that is irradiated onto the wafer 1 forms a spiral trace on the entire surface of the wafer 1, so that the entire surface of the wafer 1 can be inspected.

The clock detection unit (synchronization unit) 20 is configured to include a sensor 21, an IV conversion circuit 22 and a clock reproduction circuit 23, and generates a clock signal (C1) that is synchronized with the laser light source 2 (to its pulse oscillation) based upon components of the laser light that has transmitted through the reflection plate 3. Additionally, the clock detection unit (synchronization unit) 20 can also be configured with use of conventional techniques. The sensor 21 detects the components of the laser light that has transmitted through the reflection plate 3. The IV conversion circuit 22 performs current-voltage conversion of the output of the sensor 21. The clock reproduction circuit 23 generates a clock signal (C1) serving as a reproduction signal by a pulse signal, from the output voltage of the IV conversion circuit 22 by PLL or the like. Since the pulse oscillation from the laser light source 2 forms a high frequency, the clock detection unit 20 is provided so as to be synchronized with this pulse oscillation with high precision.

The delay control unit 24 has a delay adjusting function, and by inputting the clock signal (CI) from the clock reproduction circuit 23 therein, the delay control unit 24 supplies the resulting signal (C1′) that has been delay-adjusted to the gate signal generation unit 25, and to the ADC 8 and data processing unit 9, etc.

Moreover, in the inspection device 100 of the present embodiment, based upon the signal (C1′) obtained by delay-adjusting the clock signal generated by the clock detection unit 20, the gate signal generation unit 25 generates a gate signal (the above-mentioned G), and based upon the corresponding gate signal (G), the sensor 6 is controlled in the same manner as described above. In the same manner as described above, the sensor 6 is a light detection element configured to include the APD and MPPC, and by allowing light including scattered light from the wafer 1 serving as the sample to be made incident thereon through the lens 5, the sensor 6 generates and outputs the detection signal (the above-mentioned S) in accordance with predetermined characteristics. The detection signal (S) outputted by the sensor 6 is amplified by the amplifier circuit 7, and sampled by the ADC 8. The sampling timing in the ADC 8 follows the above-mentioned signal (C1′).

The data processing unit 9 has data information relating to the sampling result of the ADC 8 inputted therein, carries out data processing operations of predetermined measurement and inspection, and stores and outputs the results. The corresponding data are stored in a memory or the like, which is not shown, in the inspection device 100. The CPU 10 carries out processes for controlling the respective units of the entire inspection device 100. The map output unit 11 displays information on a display screen, the information including a map (for example, a two-dimensional state of the surface of the sample) that is the results of the measurement and inspection processes in the data processing unit 9. Moreover, the map output unit 11 configures a GUI for allowing the user to confirm the various pieces of information and to operate the various kinds of operations, and displays the GUI on the screen. The map output unit 11 can be configured by a PC or the like. Furthermore, as described later, the map output unit 11 and the CPU 10 also have functions for allowing the user to set various pieces of information, thereby being able to carry out adjustments on the gate signal generation unit 25 or the like. Upon carrying out the adjustments, a setting signal (CNF) is supplied from the CPU 10 to the gate signal generation unit 25.

Additionally, various elements, such as the optical system including the stage, illumination unit and detection unit, may be provided inside predetermined box members (not shown) with predetermined positional relationships and dimensions, and the positions to be disposed are not limited to the ones shown in the figures. Moreover, the respective processing units (data processing unit 9 or the like) may be configured by using, for example, hardware such as an IC or the like with predetermined logics formed therein, or may be realized by using software programming processes or the like of a general-use computer. Moreover, for example, the gate signal generation unit 25 may be configured by using an exclusively-used IC or the like, or may be configured by unifying it with one portion of the sensor 6, or may be configured by unifying it with another element shown in the figures.

[Sensor]

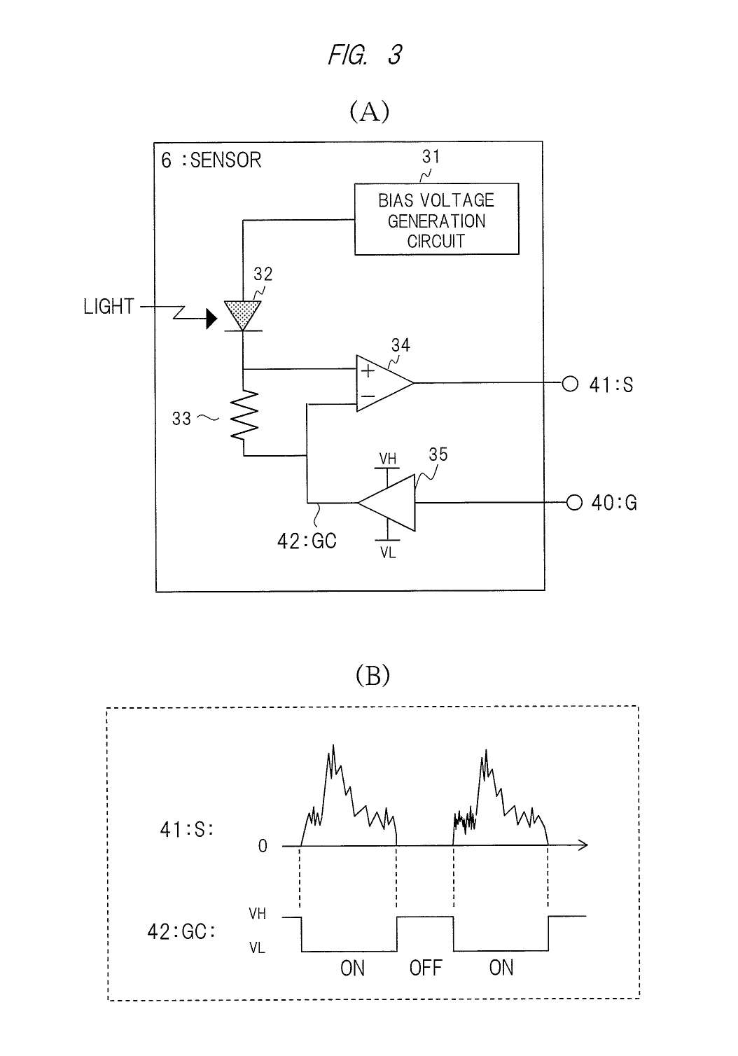

FIGS. 3(A) and 3(B) show examples of the configuration and operation of the sensor 6 that is a light detection element in the inspection device 100 in accordance with the first embodiment. FIG. 3(A) shows the circuit configuration of the sensor 6, and FIG. 3(B) shows the operation of the corresponding sensor 6.

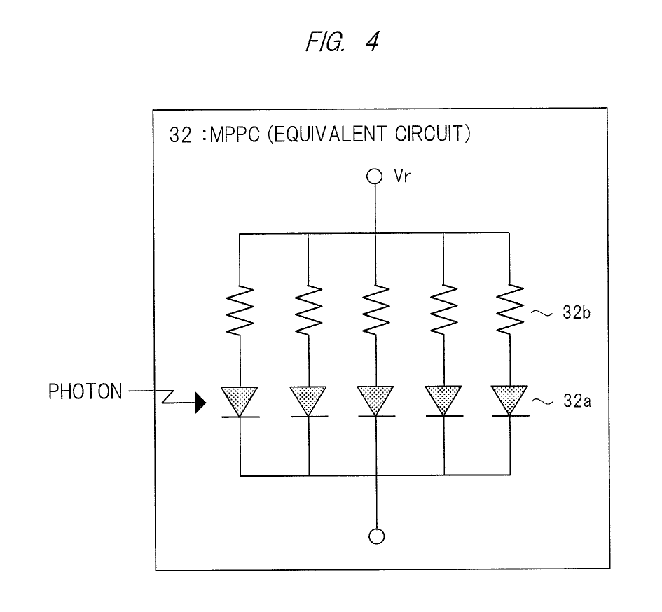

In FIG. 3(A), as shown in the figure, the sensor 6 has a configuration in which a MPPC 32 serving as a light detection element, a bias voltage generation circuit 31, a detection resistance 33, a differential amplifier circuit 34 and a driver circuit 35 are connected to one another. Moreover, the reference numeral 40 represents the above-mentioned gate signal G, 41 represents a detection signal S, and 42 represents a gain control signal (referred to as GC) to be applied to the MPPC 32. Additionally, FIG. 4 shows a configuration of the MPPC 32.

The sensor 6 generates a bias voltage by the bias generation circuit 31 and applies the voltage to the MPC 32, and also applies a gain control signal (GC) 42 in accordance with the gate signal G thereto by a driver circuit 35 through the detection resistance 33. The gain control signal (GC) 42 is a voltage signal to form a VH (high voltage) or a VL (low voltage). Thus, a voltage corresponding to a difference between the bias voltage and the gain control signal (GC) 42 is applied to two ends of the MPPC 32. Moreover, the output current of the MPPC 32 is converted to a voltage by the detection resistance 33, and the voltage between the two ends of the detection resistance 33 is differentially amplified by the differential amplifier circuit 34, so that the resulting voltage is outputted as the detection signal (GC) 41.

In this case, the multiplied current output of the MPPC 32 caused by incident light of the same quantity is varied greatly by the voltage to be applied to the MPPC 3. For this reason, a voltage for reducing the multiplication factor of the MPPC 32 is generated by a differential voltage between the bias voltage and VH, and a voltage for increasing the multiplication factor of the MPPC 32 is generated by a differential voltage between the bias voltage and VL. Thus, the MPPC 32 controls the output current by using the gain control signal (GC) 42 outputted by the driver circuit 35.

The output current of the above-mentioned MPPC 23 is an electric charge accumulated inside the MPPC 32, and in the case when the multiplication factor is low, the output of the accumulated charge is suppressed even when a light incident is made thereon (on the MPPC 32). That is, it becomes possible to control the operation state of the MPPC 32 by the gate signal (G) 40. Based upon the ON/OFF pulse of the gate signal (G) 40, the output of the detection signal (S) 41 is stopped in the case when the gain control signal (GC) 42 is the VH. Moreover, in the case of the VL, the detection voltage in accordance with the light incident (onto the MPPC 32) is outputted as the detection signal (S) 41. That is, as shown in FIG. 3(B), the ON/OFF control of the MPPC 32 serving as the light detection element can be performed dynamically by using the gate signal (G) 40. In the case when the gate signal G is the ON (VL), the voltage of the detection signal S is outputted, while in the case of the OFF (VH), no detection signal S is outputted (shut down).

[MPPC]

FIG. 4 shows a schematic configuration of an equivalent circuit of the MPPC 32. One MPPC 32 includes an array of a plurality of APD 32a. Each of the APDs 32a is operated by Geiger mode. A resistance 32b (and a quenching resistance for shortening a recovery period of time) is connected to each of the APDs 32a (corresponding to the detection resistance 33) so as to extract a signal (pulse) caused by a voltage drop in accordance with the photon to be made incident as described above (the background art). The Vr of the terminal on the upper side indicates a reverse bias voltage. The reverse bias voltage Vr is a voltage larger than the breakdown voltage of the APD 32a. An accumulated charge is outputted from the APD pixel on which light (photon) is made incident, as an electric current. Thus, the total sum of the signals (pulses) from each of the APDs 32a forms the output signal (detection signal S) of the MPPC 32.

In accordance with the inspection device 100 of the above-mentioned first embodiment, since functions for carrying out the light detection on the sensor 6 in synchronization with the pulse oscillation from the laser light source 2, and the sampling and the like on the ADC 8 are provided, the following advantages can be obtained with respect to the sensor 6 including the MPPC 32: (1) reducing influences of dark noise; (2) reducing influences of the pulse oscillation of the laser light source; and (3) improving the detection precision by properly dealing with the deterioration of the detection precision due to influences of reflected light and stray light.

### Second Embodiment

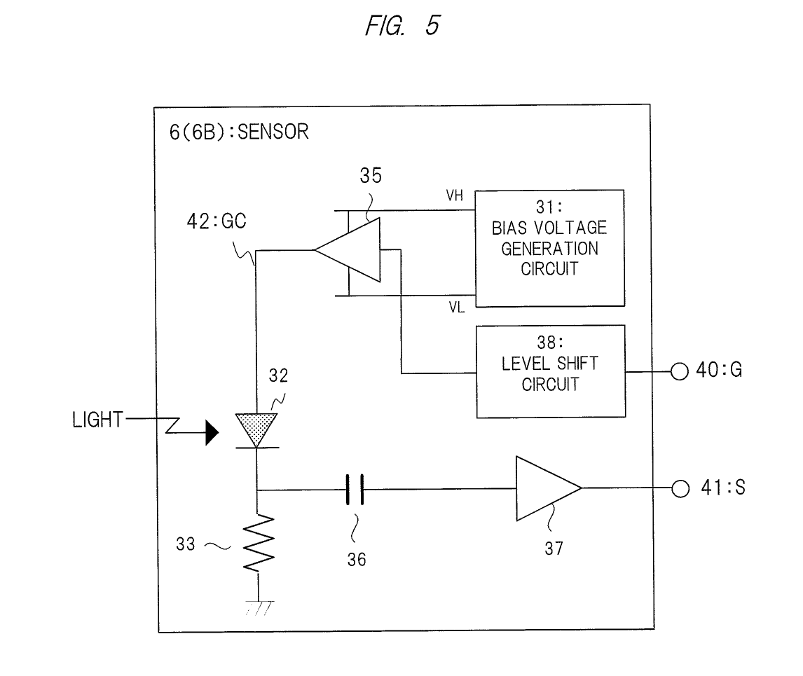

Next, by referring to FIG. 5, a second embodiment of the present invention will be described in the following description. The inspection device 100 of the second embodiment mainly differs from that of the first embodiment in the configuration of the sensor 6.

FIG. 5 shows a configuration of the sensor 6 (referred to as 6B) in accordance with the second embodiment. As shown in the figure, the sensor 6B of FIG. 5 includes a bias voltage generation circuit 31, a driver circuit 35, a level shift circuit 38, an MPPC 32, a detection resistance 33, a capacitor 36, an amplification circuit 37, etc.

In the sensor 6B, the bias voltage generation circuit 31 generates a bias voltage VL for making the multiplication factor of the MPPC 32 lower and a bias voltage VH for making the multiplication factor thereof higher, and applies these voltages to the MPPC 32 through the driver circuit 35. Moreover, based upon a gate signal (G) 40 inputted through the level shift circuit 38, the driver circuit 35 switches a bias voltage to be applied to the MPPC 32 to VH or VL.

Moreover, the output current of the MPPC 32 is converted to a detection voltage through the detection resistance 33 with one end being fixed to a reference potential, and the resulting voltage is outputted as a detection signal (S) 41 through the capacitor 36 and the amplifier circuit 37.

By using the configuration of the second embodiment, the same effects as those of the first embodiment can be obtained.

### Third Embodiment

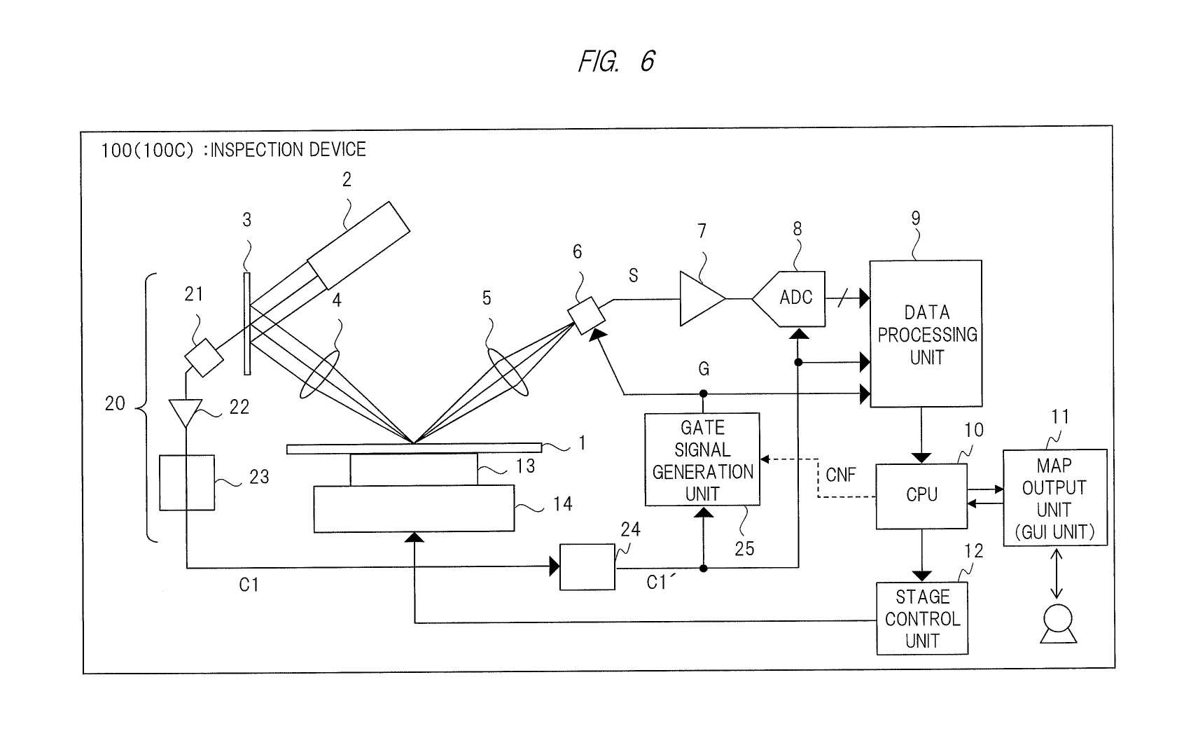

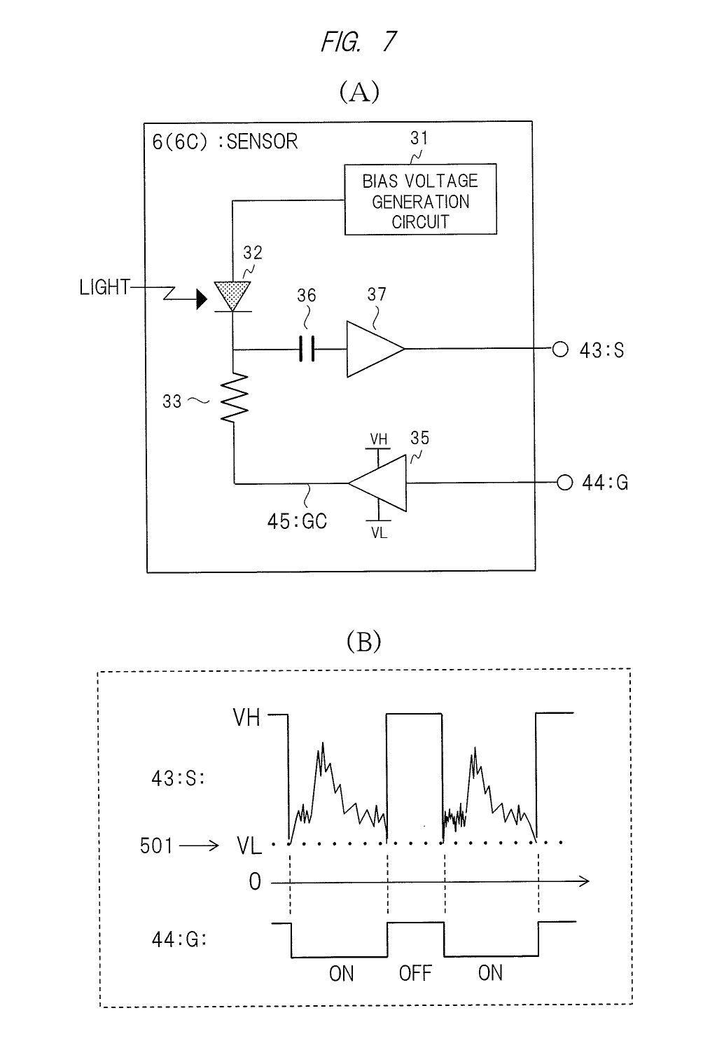

Next, by referring to FIGS. 6 and 7, a third embodiment of the present invention will be described in the following description. The inspection device 100 of the third embodiment has the many common and same elements and configurations as those of the inspection device 100 of the first embodiment; however, it differs from the first embodiment in that the gate signal G from the gate signal generation unit 25 is supplied not only to the sensor 6, but also to the data processing unit 9 and in that by using the gate signal G in the data processing unit 9, a processing operation of sampling information is carried out.

FIG. 6 shows a configuration of the inspection device 100 (referred to as 100C) in accordance with the third embodiment. The inspection device 100C of FIG. 6 has a configuration having the same elements as those shown in FIG. 1, which differs therefrom, the connection relationship and processes within the constituent elements, etc. In the data processing circuit 9, a signal (C1′) generated by delay-adjusting a reproduction clock (C1), which is generated by the clock generation unit 20, by the delay adjusting unit 24, and the gate signal G generated by the gate signal generation unit 25 are inputted. Based upon the above-mentioned input signals (C1′, G), the data processing circuit 9 carries out a data processing operation on the detection signal S sampled in the ADC 8.

FIGS. 7(A) and 7(B) show examples of the configuration and operation of the sensor 6 (referred to as 6C) in the inspection device 100C of the third embodiment. As shown in the figures, the sensor 6C has a configuration in which the MPPC 32, the bias voltage generation circuit 31, the detection resistance 33, the driver circuit 35, the capacitor 36 and the amplifier circuit 37 are connected to one another. The sensor 6C generates a bias voltage by the bias voltage generation circuit 31 and applies the voltage to the MPC 32, and also applies a gain control signal (GC) (a voltage of VH or VL) 45 in accordance with the gate signal (G) 44 thereto by the driver circuit 35 through the detection resistance 33. The VH or VL outputted by the gain control signal (GC) 45 is the same as that of the gain control signal (GC) 42 of the first embodiment 1. Moreover, the output current of the MPPC 32 is converted to a voltage by the detection resistance 33, and the resulting voltage is outputted as a detection signal 43 (S) through the capacitor 36 and the amplifier circuit 37.

In the inspection device 100 of FIG. 6, the detection signal (S) of the above-mentioned sensor 6C is sampled by the ADC 8 through the amplifier circuit 7. The ADC 8 carries out the sampling process at the timing of the above-mentioned signal (C1′). A dotted line indicating a VL level 501 of FIG. 7(B) shows the sampling points of time. Moreover, as shown in FIG. 7(B), with respect to the data of the detection signal S sampled in the ADC 8, the data processing unit 9 determines the effective period of the detection signal S and carries out a data processing operation with the use of the gate signal (G) 44 from the gate signal generation unit 25 as an effective signal (VAL). That is, during the ON period of the gate signal (G) 44, the sampling data are made effective, while during the OFF period thereof, the sampling data are made ineffective.

In accordance with the configuration of the third embodiment, the same effects as those of the configuration of the first embodiment can be obtained. Moreover, by carrying out the processing operation on the sampling information with the use of the gate signal G, the improvement of the processing precision can be expected.

<Setting Means>

Furthermore, as shown in the above-mentioned FIG. 2 or the like, as an additional function, setting means relating to the ON/OFF control by the gate signal G to be carried out on the sensor 6 from the gate signal generation unit 25 is provided. In the example of FIG. 2, a user inputs setting information relating to the gate signal control through the screen of the map output unit 11 (GUI unit). The inputted setting information is processed by the CPU 10. Moreover, the setting information (CNF) is inputted to the gate signal generation unit 25 through the CPU 10. In accordance with the setting information (CNF), the gate signal generation unit 25 adjusts the gate signal G to be applied to the sensor 6. As parameters for making the gate signal G adjustable, the magnitudes (amplitude) of the ON (corresponding VL) and OFF (corresponding VH) of gate signals G, a duty ratio of the ON/OFF, application timing (phase), etc. are used. These numeric values can be finely adjusted on the screen by using bars, buttons or the like. Thus, fine adjustments are carried out on the light detection precision of the sensor 6 by the user, thereby making it possible to contribute to the improvement of measurement and inspection precision.

<Pulse Signal>

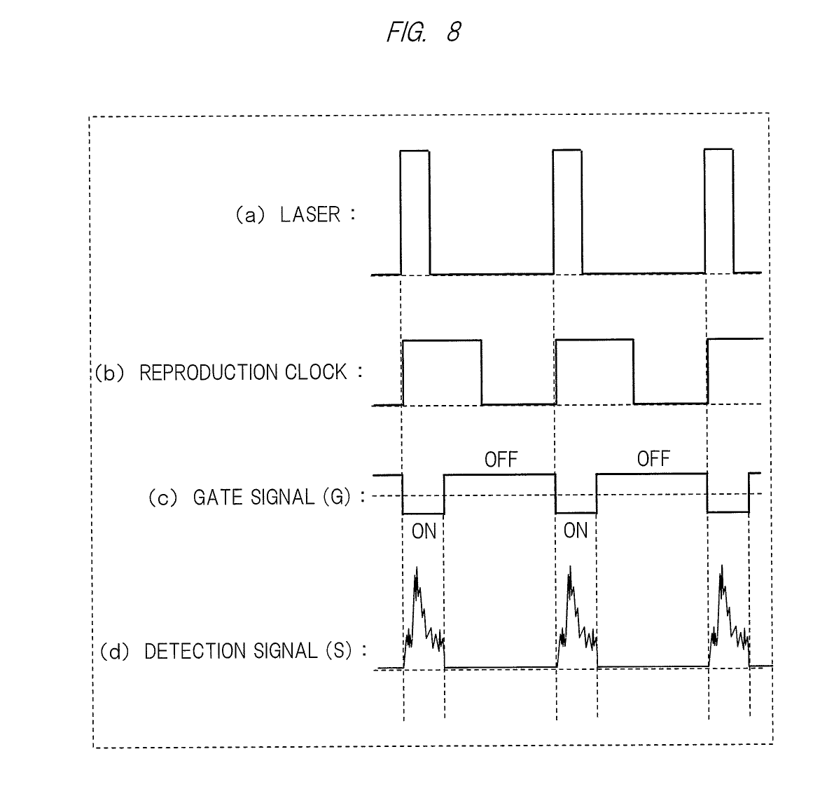

FIG. 8 shows a schematic image about the respective pulse signals as a supplement to the above-mentioned embodiments. FIG. 8(a) shows a pulse of a beam by pulse oscillation from the laser light source 2. FIG. 8(b) shows a pulse of a reproduction signal (clock signal C1) by the clock detection unit 20. FIG. 8(c) shows a gate signal G. At the time of the ON state, the multiplication rate becomes greater, and at the time of the OFF state, the multiplication rate becomes smaller. FIG. 8(d) shows the detection signal S (waveforms given as examples) of the sensor 6 (MPPC 32). Additionally, the detection signal S is given as a waveform of charge accumulation; however, this is different from the output signal of the counted value (total number).

During the ON period of the gate signal G, scattered light from the sample may be made incident thereon. During the OFF period of the gate signal G, no charge accumulation due to influences by reflected light and stray light, etc., is generated because of the OFF (small value or 0) state of the gain (multiplication rate). Therefore, the output of an undesired pulse (signal) caused by an unnecessary charge accumulation can be prevented. It becomes possible to prevent the amplification precision of the waveform from deteriorating in the next light incidence time (ON period). That is, the deterioration of the detection signal S can be prevented, and the light detection precision of the sensor 6 can be consequently enhanced.

For example, in the case of an inspection device of a dark visual field optical system that requires a high throughput in a micronized semiconductor wafer serving as a target, the frequency of the pulse oscillation from the laser light source 2 becomes high, with the result that it is necessary to detect scattered light from a foreign matter on the wafer, with high precision by the sensor 6. In such a case, by controlling the input/output of the sensor 6 by the gate signal G that is synchronized with the laser light source 2 as described above, the high precision and high throughput can be realized.

Additionally, in the present embodiment, the sensor 6 is controlled by using a pulse signal (binary signal of ON/OFF) as the gate signal G; however, the present invention is not limited to this configuration, and a signal having three or more values may be used, or a signal having a waveform whose amplitude continuously changes may be used to continuously change the magnitude of the gain and the multiplication rate.

<Light Detection Element>

Additionally, in the above-mentioned embodiment, explanation has been given by exemplifying a configuration that uses the MPPC as the light detection element (sensor 6); however, the present invention is not limited thereto, and a photodiode, a single APD, a photo multiplier tube (PMT), or the like may be used as the light detection elements. In this case, in the same manner as in the above-mentioned embodiments, by using the gate signal generation unit 25 or the like, the operation voltage of the light detection element thereof is dynamically controlled. Thus, the dynamic ON/OFF control of the light detection element can be achieved, so that the precision of the light detection can be improved.

The output and multiplication rate of the semiconductor light detection element, such as an MPPC (PPD) or the like, greatly depend on a bias voltage with respect to the APD pixel, and in the conventional countermeasures (for example, the ones in the above-mentioned Patent Document 2), the means (for example, a DAC) needs to be prepared so as to set the bias voltage with high precision (correctly). On the other hand, in accordance with the present embodiment, a configuration (FIG. 1) which is provided with the means (detection control unit 104) for dynamically controlling the input/output operations of the detection unit 102 by using a gate signal in synchronization with the irradiation unit 101 is proposed. In particular, the configuration that performs pulse-control (ON/OFF control) of the bias voltage by using the gate signal G is proposed. This makes it possible to realize light detection with high precision.

<Effects, etc>

As described above, in accordance with the inspection devices 100 of the respective embodiments, such a function for carrying out a light detection by the sensor 6 and a sampling or the like by the ADC 8 in synchronization with the pulse oscillation from the laser light source 2 is provided, so that, with respect to the sensor 6 including the light detection element such as the MPPC 32 or the like, the following effects can be obtained: (1) reducing influences of dark noise; (2) reducing influences of the pulse oscillation of the laser light source; and (3) improving the detection precision by dealing with the deterioration of the detection precision due to influences of reflected light and stray light. Thus, it becomes possible to measure and detect with high precision, a state of the inspection device 100 including a fine foreign matter, defect or the like onto the surface of the sample.

In the foregoing, the invention made by the inventors of the present invention has been concretely described based on the embodiments. However, it is needless to say that the present invention is not limited to the foregoing embodiments and various modifications and alterations can be made within the scope of the present invention. For example, all of the above-described elements are not necessarily included in the present invention, and such elements can be replaced with other elements, or other elements can be added instead. Further, an embodiment combining the respective embodiments is also possible.

As another embodiment, the inspection device includes a laser light source serving as light irradiation means and a sensor device serving as light detection means, and further includes control means for performing pulse-control of a voltage applied to the sensor device and a gain of the sensor device in synchronization with the laser light of the light irradiation means. The above-mentioned control means generates a gate signal for controlling the pulse, and applies the gate signal to the sensor device. The sensor device includes, for example, a sensor element for outputting an electric current in accordance with incident light, a driver circuit for applying a predetermined voltage to the sensor element in accordance with the gate signal, a resistance element for converting an output current of the element to a voltage, and an amplifier element for differentially amplifying the voltage generated between the two ends of the resistance element, and carries out a detecting operation in accordance with the gate signal. Moreover, the above-mentioned sensor device controls the amplifying operation in accordance with the gate signal. Moreover, the above-mentioned sensor device differentially detects the detection signal based upon the gain control voltage and the sensor output voltage.

### EXPLANATIONS OF REFERENCE NUMERALS

1 . . . wafer, 2 . . . laser light source, 3 . . . reflection plate, 4, 5 . . . lens, 6 . . . sensor, 7 . . . amplifier circuit, 8 . . . ADC (analog/digital conversion circuit), 9 . . . data processing unit, 10 . . . CPU, 11 . . . map output unit (GUI unit), 12 . . . stage control unit, 13 . . . rotation stage, 14 . . . translation stage, 20 . . . clock detection unit, 21 . . . sensor, 22 . . . IV conversion circuit, 23 . . . clock reproduction circuit, 24 . . . delay adjusting unit (delay control unit), 25 . . . gate signal generation unit, and 100 . . . inspection device

1. An inspection device that measures and inspects a state of a sample comprising:
an irradiation unit that irradiates a beam by pulse oscillation onto a surface of the sample from a laser light source;
a detection unit on which light from the surface of the sample by the irradiation is made incident to generate and output a detection signal;
a first synchronization unit that generates a first clock signal in synchronization with an ON/OFF timing of the pulse oscillation of the irradiation unit;
a detection control unit that generates a first signal for controlling an input/output of the detection unit based upon the first clock signal, and applies the first signal to the detection unit,
a sampling unit that samples a detection signal from the detection unit; and
a second synchronization unit that applies a second signal that is made synchronized with the first clock signal or the first signal to the sampling unit, so as to be made synchronized, with the detection unit,
wherein the detection unit generates and outputs the detection signal based upon the first signal in a case where the pulse oscillation is ON, and the sampling unit samples the detection signal based upon the second signal.

2-3. (canceled)

4. The inspection device according to claim 1, further comprising:
a sampling unit that samples a detection signal from the detection unit; and
a data processing unit that carries out a predetermined data processing, with sampling data from the sampling unit being inputted therein,
wherein the data processing unit determines whether the sampling data is effective or ineffective based upon input of the first signal or the first clock signal.

5. (canceled)

6. The inspection device according to claim 1,
wherein the first signal is a gate signal for switching a gain and a multiplication rate in the detection unit, and
the detection unit generates the detection signal at the gain and the multiplication rate in accordance with a magnitude of a value of the gate signal.

7. The inspection device according to claim 1,
wherein the detection unit is configured to include an APD or an MPPC, as a light detection element for generating and outputting a detection signal with the light being made incident thereon.

8. The inspection device according to claim 1,
wherein the detection unit includes:
a light detection element on which the light is made incident;
a first voltage supply unit that supplies a first voltage to one end of the light detection element;
a detection resistance connected to the other end of the light detection element; and
a second voltage supply unit that is connected to the other end of the detection resistance to supply a second voltage thereto,
a magnitude of the first voltage of the voltage supply unit or the second voltage of the second voltage supply unit is controlled in accordance with input of the first signal.

9. The inspection device according to claim 8,
wherein the detection unit includes:
a differential amplifier element that is connected to the detection resistance; and
a driver circuit that is connected to the other end of the detection resistance,
the differential amplifier element amplifies a terminal voltage of the detection resistance and outputs the resulting voltage as the detection signal, and
the driver circuit switches a low voltage or a high voltage based upon input of the first signal, and outputs the resulting voltage as a gain control signal.

10. The inspection device according to claim 1,
wherein the detection unit includes:
a light detection element on which the light is made incident;
a driver circuit that is connected to one end of the light detection element;
a detection resistance that is connected to the other end of the light detection element, with the other end connected to a reference electric potential;
a voltage supply unit that supplies a low voltage and a high voltage to the driver circuit;
a level shift circuit that supplies a signal in accordance with input of the first signal to the driver circuit;
a capacitance element that is connected to the other end of the light detection element; and
an amplifier element that is connected to the capacitance element and outputs the detection signal,
the driver circuit switches the low voltage and the high voltage, and outputs the resulting voltages as a gain control signal in accordance with the signal from the level shift circuit.

11. The inspection device according to claim 1,
wherein the detection unit includes:
a light detection element on which the light is made incident;
a first voltage supply unit that supplies a first voltage to one end of the light detection element;
a detection resistance that is connected to the other end of the light detection element;
a capacitance element that is connected to the other end of the light detection element;
an amplifier element that is connected to the capacitance element and outputs the detection signal; and
a driver circuit that is connected to the other end of the detection resistance,
the driver circuit switches the low voltage or the high voltage, and outputs the resulting voltage as a gain control signal in accordance with input of the first signal.

12. The inspection device according to claim 1,
wherein the detection unit is configured to include a light detection element on which scattered light from a surface of the sample is made incident to generate and output a detection signal, and includes an amplifier circuit that amplifies the detection signal from the light detection element, and
a sampling unit that samples the detection signal from the detection unit includes an ADC that performs analog/digital conversion to output of the amplifier circuit;
the inspection device includes:
a data processing unit that carries out data processing for a predetermined measurement and inspection, with sampling data from the ADC being inputted therein;
a control unit that controls an entire device;
a user interface unit that carries out a process for providing a user interface including a process for displaying a result of the data processing on a screen; and
a stage control unit that controls a stage on which the sample is mounted.

13. An inspection method to be carried out in an inspection device that measures or inspects a state of a sample, comprising:
an irradiation step of irradiating a beam by pulse oscillation onto a surface of the sample from a laser light source;
a detection step of generating and outputting a detection signal, with light from the surface of the sample by the irradiation being made incident;
a first synchronizing step of generating a first clock signal, in synchronization with an ON/OFF timing of the pulse oscillation of the irradiation step;
a detection control step of generating a first signal to be applied, the first signal for controlling an input/output of the detection step, based upon the first clock signal;
a sampling step of sampling a detection signal outputted in the detection step; and
a second synchronization step that applies a second signal that is made synchronized with the first clock signal, or the first signal in the sampling step, so as to be made synchronized with the detection step,
wherein the detection step generates and outputs the detection signal based upon the first signal in a case where the pulse oscillation is ON, and the sampling step samples the detection signal based upon the second signal.

14-15. (canceled)
